(19) United States
(12) Patent Application Publication
(10) Pub. No.: US 2015/0198940 A1
(43) Pub. Date: Jul. 16, 2015

(54) ELECTRONIC HOME APPLIANCE AND CONTROL METHOD THEREOF

(71) Applicant: LG ELECTRONICS INC., Seoul (KR)

(72) Inventors: Kyungeun HWANG, Seoul (KR); Soomin SEO, Seoul (KR); Youjin LEE, Seoul (KR)

(21) Appl. No.: 14/593,042

(22) Filed: Jan. 9, 2015

(30) Foreign Application Priority Data
Jan. 10, 2014 (KR) 10-2014-0003519

(51) Int. Cl. G05B 15/02

(52) U.S. Cl. CPC G05B 15/02

(57) ABSTRACT

An electric home appliance includes a sensing unit configured to sense whether a user's body is within a predetermined range from the electric home appliance and to determine a distance value of the user's body from the electric home appliance, an output unit configured to output information, and a controller configured to determine, from among a plurality of predetermined distance ranges, a distance range that corresponds to the distance value of the user's body from the electric home appliance and to select, from among a plurality of information output modes, an information output mode of the output unit based on the determined distance range.

### CROSS-REFERENCE TO RELATED APPLICATION

This application claims the priority benefit of Korean Patent Application No. 10-2014-0003519, filed on Jan. 10, 2014, in the Korean Intellectual Property Office, the disclosure of which is incorporated herein by reference.

### TECHNICAL FIELD

The present application relates to an electric home appliance and a control method thereof.

### BACKGROUND

In general, an electric home appliance can include an air conditioner for conditioning indoor air, a laundry treatment apparatus for treating laundry, or a refrigerator for storing food. For example, the laundry treatment apparatus may include a washing machine, a drying machine, and a washing and drying machine.

The washing machine is an apparatus that can perform a series of processes including washing, rinsing, and spin-drying to remove contaminants from laundry, such as clothing and bedding, using water, detergent, and mechanical actions. The washing machine may be classified as a top load type washing machine configured such that a drum, in which laundry is placed, is rotated about a vertical shaft or a front load type washing machine configured such that a drum, in which laundry is placed, is rotated about a horizontal shaft.

The drying machine is an apparatus that can apply hot air to laundry, such as clothing, to dry the laundry. Specifically, laundry is introduced into a drum, and hot air or cold air is supplied into the drum during rotation of the drum to dry the laundry.

The washing and drying machine is an apparatus having both a washing function and a drying function. Specifically, laundry is introduced into a drum, and a desired function is executed during rotation of the drum to wash or dry the laundry.

The electric home appliance, such as the laundry treatment apparatus, may provide an operation state of the electric home appliance to a user. In some cases, there may be a need for a method of effectively providing information based on situation of the user.

### SUMMARY

It is an object of the present application to provide an electric home appliance that is capable of deciding an information output mode of an output unit based on location of a user and a control method thereof.

According to one aspect, an electric home appliance includes a sensing unit configured to sense whether a user's body is within a predetermined range from the electric home appliance and to determine a distance value of the user's body from the electric home appliance, an output unit configured to output information, and a controller configured to determine, from among a plurality of predetermined distance ranges, a distance range that corresponds to the distance value of the user's body from the electric home appliance and to select, from among a plurality of information output modes, an information output mode of the output unit based on the determined distance range.

Implementations of this aspect may include one or more of the following features. For example, the controller may be configured to determine a size of text, a type, quality, and volume of a notification sound, or a type of information output by the output unit based on the determined distance range. The controller may be configured to determine a size of text of information that is output by the output unit based on the determined distance range. The controller may be configured to determine a type, quality, and volume of a notification sound that is output by the output unit based on the determined distance range. The controller may be configured to determine a type of information that is output by the output unit based on the determined distance range. The plurality of predetermined distance ranges may include a first distance range, a second distance range that is greater than the first distance range, and a third distance range that is greater than the second distance range; the controller may be configured to control the output unit to display at least one selected from among a current time, a current use mode, and a remaining operation time of the current use mode based on the distance value of the user's body being within the third distance range. The controller may be configured to control the output unit to display a current time based on the distance value of the user's body being within the third distance range. The controller may be configured to control the output unit to display a current use mode based on the distance value of the user's body being within the third distance range. The controller may be configured to control the output unit to display a remaining operation time of a current use mode based on the distance value of the user's body being within the third distance range.

Further according to this aspect, the controller may be configured to control the output unit to display various temperature values necessary for control or a procedure of the current use mode based on the distance value of the user's body being within the second distance range. The controller may be configured to control the output unit to display information for function setting based on the distance value of the user's body being within the first distance range. The controller may be configured to increase a quantity of information that is output by the output unit based on the distance value of the user's body decreasing. The output unit may include a speaker configured to output a notification sound indicating an operation state of the electric home appliance, and the controller may be configured to adjust a volume of the speaker based on the distance value of the user's body.

According to another aspect, a control method of an electric home appliance includes sensing, via a sensing unit, whether a user's body is within a predetermined range from the electric home appliance, calculating a distance value of the user's body from the electric home appliance, and determining an information output mode of an output unit based on presence or absence of the user's body and the distance value.

Implementations of this aspect may include one or more of the following features. For example, determining the information output mode of the output unit may include increasing a quantity of information that is output by the output unit as the distance value of the user's body decreases. Determining the information output mode of the output unit may include determining, from among a plurality of predetermined distance ranges, a distance range that corresponds to the distance value of the user's body from the electric home appliance and deciding a quantity of information that is output by the output unit based on the determined distance range. Determining the information output mode of the output unit may include deciding a size of text, a type, quality, and volume of a notification sound, or a type of information that is output by the output unit based on the determined distance range. Determining the information output mode of the output unit may include deciding a size of text that is output by the output unit based on the determined distance range.

### BRIEF DESCRIPTION OF THE DRAWINGS

The above and other objects, features and other advantages of the present application will be more clearly understood from the following detailed description taken in conjunction with the accompanying drawings, in which:

FIG. 1 is a perspective view showing an example washing machine according to an implementation of the present application;

FIG. 2 is a block diagram showing components of an electric home appliance according to another implementation of the present application;

FIGS. 3 to 5 are views showing example information output modes of the electric home appliance according to the implementation of the present application;

FIGS. 6 and 7 are views showing a control process of the electric home appliance according to the implementation of the present application; and

FIG. 8 is a view showing a control method of an electric home appliance according to an implementation of the present application.

### DETAILED DESCRIPTION

Advantages and features of the present application and a method of achieving the same will be more clearly understood from implementations described below with reference to the accompanying drawings. However, the present application is not limited to the following implementations but may be implemented in various different forms. The implementations are provided merely to complete disclosure of the present application and to fully provide a person having ordinary skill in the art to which the present application pertains with the category of the application. The application is defined only by the category of the claims. Wherever possible, the same reference numbers will be used throughout the specification to refer to the same or like parts.

Terms used in the description of the application are provided only to explain specific implementations but are not intended to restrict the application. In the description of the application and the accompanying claims, the singular forms are intended to include the plural forms as well, unless context clearly indicates otherwise. The use of marks may indicate any one or both of the singular forms and the plural forms of the terms, and vice versa.

It will be understood that the term “and/or” refers to one or more possible combinations of specified relevant items and includes such combinations. It will be further understood that the terms “comprises” or “comprising” used in this specification designate presence of specified features, integers, steps, operations, elements, and/or components but do not exclude presence or addition of one or more other features, integers, steps, operations, elements, components, and/or groups thereof.

Hereinafter, implementations of computing devices, user interfaces for the computing devices, and related processes necessary to use the computing device may be described.

Reference will now be made in detail to the preferred implementations of the present application, examples of which are illustrated in the accompanying drawings. Hereinafter, a washing machine, which is one example of an electric home appliance, will be described by way of example. However, the present application is not limited thereto. For example, the idea of the present application may be applied to other laundry treatment apparatuses, such as a drying machine, an oven, an air conditioner, and a refrigerator.

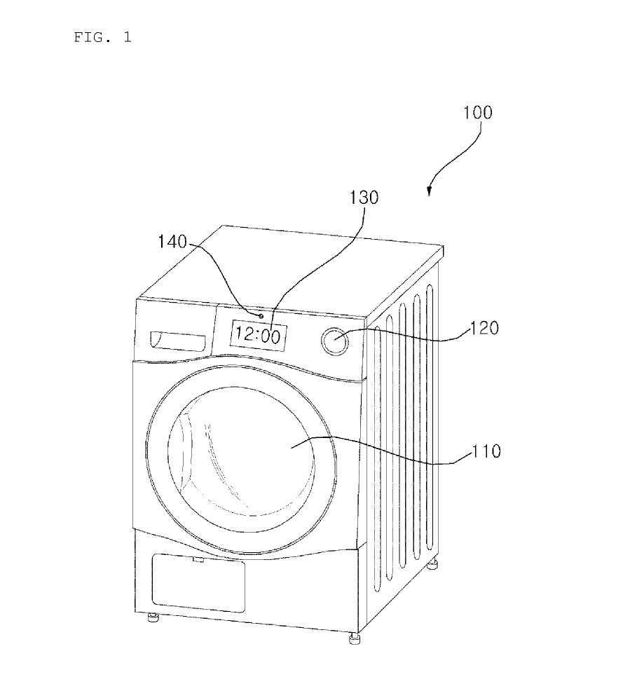

Referring to FIG. 1, a washing machine 100, which is one example of an electric home appliance according to an implementation of the present application, may include a case forming the external appearance of the washing machine and a drum rotatably provided in the case for receiving laundry, such as clothing. The drum may be provided at an internal circumferential surface thereof with a plurality of lifters for lifting clothing upward and dropping the clothing downward when the drum is rotated.

The case may be provided at the front thereof with a clothing introduction port, which can be opened such that clothing may be introduced into the drum through the clothing introduction port. The case may be provided at the upper side of the front thereof with an output unit 130 for outputting control information of the washing machine. The output unit 130 may include a light source, such as a liquid crystal display (LCD) or a light emitting diode (LED), for displaying control information of the washing machine. However, the present application is not limited thereto.

A door 110 may be mounted at the clothing introduction port. The door 110 may open and close the clothing introduction port, which is an entrance through which clothing is introduced into the drum. The door 110 may be manually manipulated by a user or operated according to electronic control. The door 110 may be hingedly connected to the case.

An input unit 120 may be disposed at the front of the washing machine 100. The input unit 120 may be protruded or retreated. However, the present application is not limited thereto. For example, the input unit 120 may be configured in the form of a rotary dial. The input unit 120 may be disposed in the case of the washing machine and may be protruded outward from the case depending upon location of the user.

The output unit 130 may output various kinds of information. The output unit 130 may display an operation mode, an operation time, or weather information. However, the present application is not limited thereto. In FIG. 1, the output unit 130 is shown as a display unit for visually displaying information. However, the present application is not limited thereto. For example, the output unit 130 may include a speaker for aurally outputting information. Idea of the present application may be applied to the display unit or the speaker as the output unit 130 for outputting information. However, the output unit 130 is not limited to any one selected from between the display unit and the speaker.

The output unit 130 may change an information display mode when a user approaches the washing machine.

The electric home appliance may include a sensing unit 140 for sensing whether an object is in front of the electric home appliance. The sensing unit 140 may sense whether an object is within a predetermined distance from the electric home appliance 100. For example, the sensing unit 140 may sense whether a human body is within a predetermined range. The sensing unit 140 may be disposed at the upper part of the middle of the case. However, the present application is not limited thereto. For example, the sensing unit 140 may be disposed at the upper end of the right side or the left side of the case depending upon the type of a sensor included in the sensing unit 140.

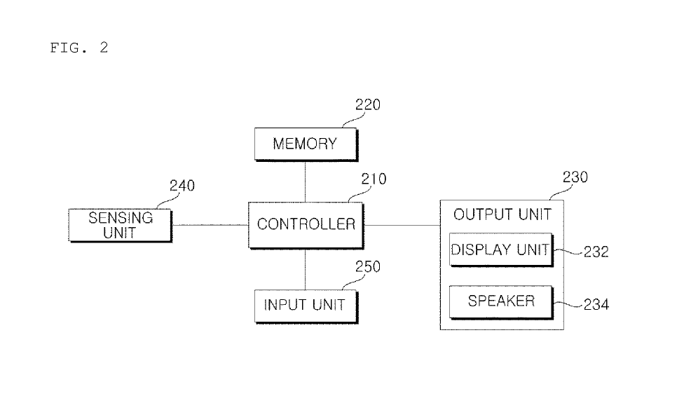

FIG. 2 is a block diagram showing components of an electric home appliance according to another implementation of the present application.

Referring to FIG. 2, the electric home appliance according to the implementation of the present application may include a sensing unit 240 for sensing whether a human body is within a predetermined range, an output unit 230 for outputting information, and a controller 210 for deciding an information output mode of the output unit 230 based on presence or absence of the human body sensed by the sensing unit 240.

The controller 210 may control operation of the electric home appliance. The controller 210 may transmit and receive a control signal to and from the other components of the electric home appliance. The controller 210 may transmit a signal to each component of the electric home appliance to control each component.

The controller 210 may output data stored in a memory 220 to the output unit 230 or execute a program stored in the memory 220 to process the data.

The controller 210 may recognize a time during which the human body is within the predetermined range. For example, the controller 210 may recognize whether the human body is within the predetermined range based on a signal output as a result of presence or absence of an object sensed by the sensing unit 240.

The controller 210 may recognize whether the human body is within the predetermined range for a predetermined time or more. In a case in which the human body deviates from the predetermined range, the controller 210 may initialize time. In a case in which the human body reenters the predetermined range, the controller 210 may recalculate time from the beginning.

In a case in which the human body is within the predetermined range for the predetermined time or more, the controller 210 may add the number of information items output by the output unit 230. For example, in a case in which the human body is within the predetermined range for less than the predetermined time, the controller 210 may output a current time through the output unit 230. On the other hand, in a case in which the human body is within the predetermined range for the predetermined time or more, the controller 210 may further output information regarding a use mode through the output unit 230. However, the present application is not limited thereto.

The controller 210 may control the output unit 230 to output information in different modes according to the distance from the human body. For example, as the distance from the human body decreases, the controller 210 may control the output unit 230 to output detailed information. On the other hand, as the distance from the human body increases, the controller 210 may control the output unit 230 to output simple information. For example, in a case in which the distance from the human body is large, the controller 210 may control the output unit 230 to output only a current time.

As the distance from the human body decreases, the controller 210 may increase quantity of information output by the output unit 230. As the distance from the human body increases, the controller 210 may decrease quantity of information output by the output unit 230. As the distance from the human body increases, the controller 210 may simplify a format of information output by the output unit 230.

The controller 210 may set a plurality of distance ranges. The controller 210 may decide a format of information output by the output unit 230 based on a distance range, within which the distance value from the human body is, among the predetermined distance ranges.

The controller 210 may decide the type, display mode, etc. of information output by the output unit 230 based on a distance value from the human body. For example, the controller 210 may decide the size of text output by the output unit 230, the type, quality, and volume of the notification sound output by the output unit 230, or the type of information output by the output unit 230 based on a distance range, within which the distance value from the human body is.

For example, the controller 210 may set a plurality of distance ranges. The distance ranges may include a first distance range, a second distance range greater than the first distance range, and a third distance range greater than the second distance range.

In some cases, the output unit 230 includes a display unit 232 for visually outputting information.

In a case in which the distance value from the human body is within the third distance range, the controller 210 may control the output unit 230 to output at least one selected from among a current time, a current use mode, and a remaining operation time of the current use mode. In a case in which the distance value from the human body is within the second distance range, the controller 210 may control the output unit 230 to display various temperature values necessary for control or a procedure of a current use mode. In a case in which the distance value from the human body is within the first distance range, the controller 210 may control the output unit 230 to display information for function setting.

The controller 210 may decide luminance of the display unit 232 based on the distance value from the human body. For example, as the distance value from the human body decreases, the controller 210 may decrease a luminance value of the display unit 232. On the other hand, as the distance value from the human body increases, the controller 210 may increase the luminance value of the display unit 232.

The controller 210 may determine whether the human body gazes at the electric home appliance. For example, the sensing unit 240 may sense pupils of the human body and the controller 210 may determine whether the human body gazes at the electric home appliance based on motion of the pupils of the human body. The controller 210 may adjust luminance of the display unit 232 based on the determination as to whether the human body gazes at the electric home appliance. For example, in a case in which the human body gazes at the electric home appliance, the controller 210 may decrease the luminance of the display unit 232. However, the present application is not limited thereto.

In some cases, the output unit 230 includes a speaker 234 for aurally outputting information.

The controller 210 may output a notification sound through the output unit 230. For example, as the distance value from the human body increases, the controller 210 may decrease quality of the notification sound output by the output unit 230. For example, as the distance from the human body increases, the controller 210 may widen a sampling interval of the notification sound output by the output unit 230. However, the present application is not limited thereto.

As the distance value from the human body decreases, the controller 210 may increase quality of the notification sound output by the output unit 230. For example, as the distance from the human body decreases, the controller 210 may narrow the sampling interval of the notification sound output by the output unit 230. However, the present application is not limited thereto.

The controller 210 may adjust volume of the output unit 230 based on the distance value from the human body. For example, as the distance from the human body decreases, the controller 210 may decrease the volume of the output unit 230. On the other hand, as the distance from the human body increases, the controller 210 may increase the volume of the output unit 230.

In a case in which the speaker 234 outputs a notification sound and there is no user response for a predetermined time or more, the controller 210 may change the type of the notification sound output by the speaker 234 or increase the volume of the notification sound.

The controller 210 may determine presence or absence of use information of the human body sensed by the sensing unit 240. The controller 210 may analyze identity of the human body using the electric home appliance. For example, the controller 210 may store use information, including information regarding whether the human body sensed by the sensing unit 240 has used the electric home appliance, in the memory 220. For example, the controller 210 may store use information, including information regarding the shape, size, fingerprint, etc. of the human body sensed by the sensing unit 240, in the memory 220.

The controller 210 may determine presence or absence of use information corresponding to the human body sensed by the sensing unit 240. In a case in which the use information is present, the controller 210 may display a plurality of use modes through the output unit 230 based on the use information. For example, the controller 210 may output the use modes through the output unit 230 in order of high use frequency based on the use information. However, the present application is not limited thereto.

In a case in which the use information is absent, the controller 210 may display all manipulatable functions, a sequence of cycles, remaining time, and other detailed information through the output unit 230. However, the present application is not limited thereto.

Meanwhile, the controller 210 may be embodied using at least one selected from among application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing other functions.

The memory 220 may include a high-speed random access memory. The memory 220 may include nonvolatile memories, such as one or more magnetic disc storage devices, flash memory devices, or other nonvolatile solid memory devices. However, the present application is not limited thereto. The memory 220 may include a readable storage medium.

For example, the memory 220 may include an electronically erasable and programmable read only memory (EEP-ROM). However, the present application is not limited thereto. Information may be written into the EEP-ROM or removed from the EEP-ROM under control of the controller 210. The EEP-ROM may be a storage device that retains information without removal of the information even when the electric home appliance is powered off and, therefore, power is not supplied to the EEP-ROM.

The memory 220 may be interlocked with the controller 210 to store various programs or data. Programs stored in the memory 220 may be executed by the controller 210.

The output unit 230 may display various kinds of information. The output unit 230 may include a display unit 232 for visually displaying various kinds of information or a speaker 234 for aurally outputting various kinds of information.

The display unit 232, which is the output unit 230 for visually displaying information, may include at least one selected from among a light emitting polymer display (LPD), a liquid crystal display, a thin film transistor-liquid crystal display, an organic light-emitting diode, a flexible display, and a three-dimensional (3D) display. However, the present application is not limited thereto.

The output unit 230 may output information necessary to control the electric home appliance. For example, in a case in which the electric home appliance is a washing machine, the output unit 230 may output a washing mode, a washing time, etc. However, present application is not limited thereto. The output unit 230 may display all information necessary to control the washing machine.

The sensing unit 240 may be disposed at the front of the electric home appliance. The sensing unit 240 may sense whether an object is within a predetermined range. For example, the sensing unit 240 may include at least one selected from among a camera, a kinetic sensor, an infrared sensor, and an ultrasonic sensor. However, the present application is not limited thereto. The sensing unit 240 may include any sensor that is capable of sensing presence or absence, distance, shape, or size of a human body.

The sensing unit 240 may sense whether an object is within a predetermined range and transmit information regarding presence or absence of the object to the controller 210. The sensing unit 240 may sense a distance from an object or a human body.

For example, the sensing unit 240 may include a stereo camera. In this case, the electric home appliance 100 may include an image processor. The image processor may recognize a distance from an object or a human body based on stereo images acquired by the stereo camera. The image processor may be configured separately from the controller 210 and may be included in the sensing unit 240. Alternatively, the image processor may be modularized as a software component and may be included in the controller 210. In some cases, the sensing unit 240 may include a mono camera. In this case, the electric home appliance 100 may include an image processor. The image processor may recognize a distance from an object or a human body based on the change in size of the object or the human body in images acquired by the mono camera. The image processor may be configured separately from the controller 210 and may be included in the sensing unit 240. Alternatively, the image processor may be modularized as a software component and may be included in the controller 210.

For example, in a case in which the sensing unit 240 includes an ultrasonic sensor, the sensing unit 240 may sense a distance from an object or a human body through a time difference between transmitted and received signals.

For example, the sensing unit 240 may include an infrared sensor and a camera. In this case, when an infrared laser beam is emitted to an object or a human body, an image sensor included in the camera may receive a reflected laser beam point to measure a distance per pixel. The sensing unit 240 may sense the distance from the object or the human body based on the measured distance per pixel.

In some cases, the kinetic sensor may include a depth sensor. The depth sensor may include an image sensor, such as a complementary metal-oxide-semiconductor (CMOS) sensor or a charge-coupled device (CCD) sensor, or an infrared laser beam projector. When an infrared laser beam is emitted to an object or a human body, the image sensor may receive a reflected laser beam point to measure a distance per pixel. The sensing unit 240 may sense the distance from the object or the human body based on the measured distance per pixel.

In a case in which the sensing unit 240 includes a camera, the sensing unit 240 may sense whether a human body gazes at the electric home appliance. Specifically, the camera may detect pupils of the human body. At this time, an image processor may detect the pupils using a circular detection template, a circular edge detection method, a Daugman's circular edge detection method, etc. Alternatively, the image processor may detect the pupils using Hough transform, Haar-like feature, Adaboost algorithm, etc. The image processor may be configured separately from the controller 210. Alternatively, the image processor may be functionally modularized and may be included in the controller 210.

The input unit 250 may allow a user's input. The input unit 250 may be a dial that can be rotated by manipulation of a user. However, the present application is not limited thereto. For example, the input unit 250 may be a touch pad or a mechanical button.

The input unit 250 may be enabled or disabled by a command from the controller 210. The input unit 250 may be protruded or retreated by the command from the controller 210. When the user is near the electric home appliance, the input unit 250 may be protruded or enabled. When the user deviates from a predetermined range, the input unit 250 may return to the original position thereof or may be disabled. However, the present application is not limited thereto.

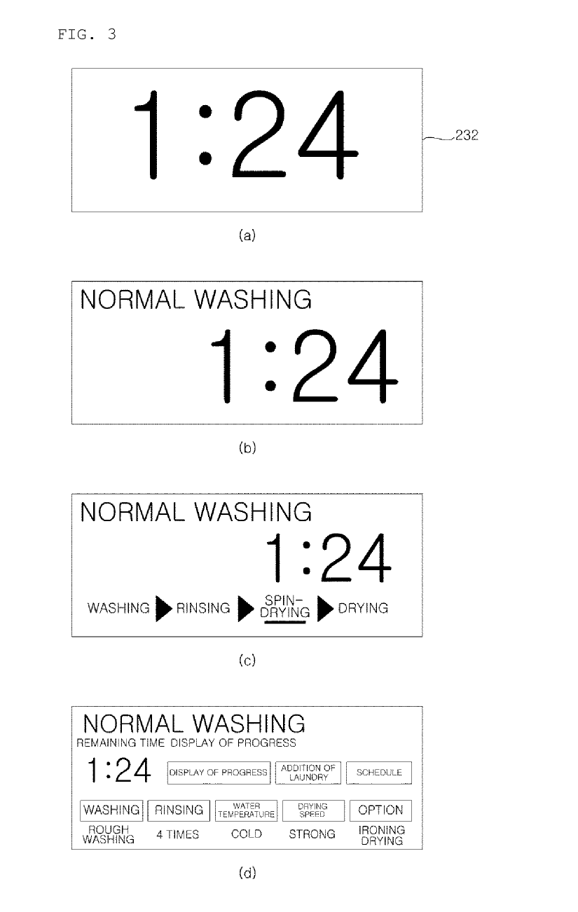

FIGS. 3 to 5 illustrate example information output modes of the electric home appliance according to the implementation of the present application.

Referring to FIG. 3, in a case in which an output unit of a washing machine, which is one example of the electric home appliance according to the implementation of the present application, is a display unit 232 for visually outputting information, it is possible to recognize an output mode of the display unit, which, however, is merely an implementation of the present application and the scope of the present application is not limited by this implementation.

FIGS. 3(a), 3(b), 3(c), and 3(d) show display modes of the output unit based on which of the distance ranges, within which the distance value from the human body is. As illustrated, the distance value from the human body sequentially decreases in order from FIG. 3(a) to FIG. 3(d).

Referring to FIG. 3(a), the display unit 232 may output a current time. In a case in which the human body is not within the predetermined range, the display unit 232 may output the current time.

Referring to FIG. 3(b), the display unit 232 may further output a current use mode of the electric home appliance. For example, in a case in which the human body is within the predetermined range for the predetermined time or more, the display unit 232 may further output the current use mode of the electric home appliance.

Referring to FIG. 3(c), the display unit 232 may display a procedure of the current use mode of the electric home appliance. For example, in a case in which the electric home appliance is being currently operated in a use mode corresponding to normal washing, the display unit 232 may output information indicating that washing, rinsing, spin-drying, and drying procedures are being sequentially performed.

The display unit 232 may output a procedure which is being currently performed. For example, the display unit 232 may underline text corresponding to spin-drying, which is a procedure which is being currently performed, to indicate that spin-drying is being currently performed.

Referring to FIG. 3(d), the display unit 232 may display information for function setting. For example, in a case in which the electric home appliance is a washing machine, the display unit 232 may output objects for setting functions, such as operation/pause, addition of laundry, schedule, washing, rinsing, water temperature, drying speed, and an option. However, the present application is not limited thereto.

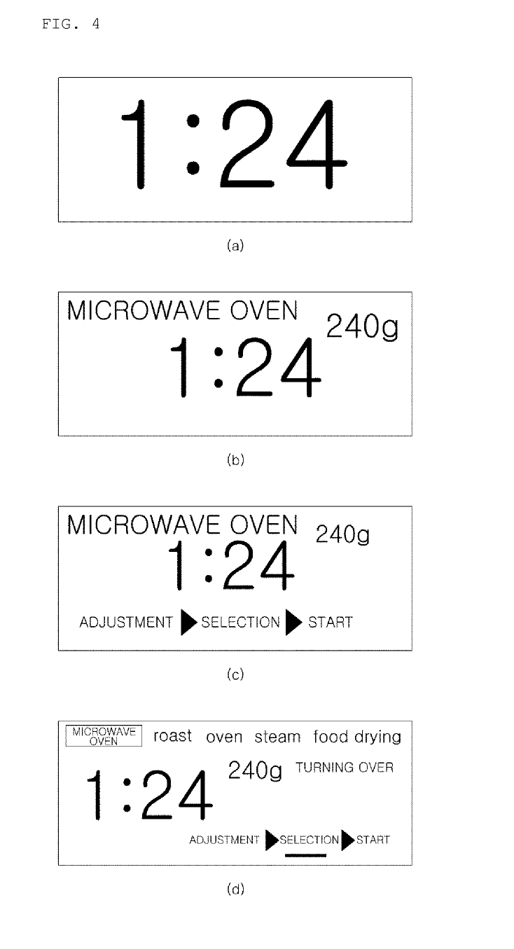

Referring to FIG. 4, in a case in which an output unit of an oven, which is another example of the electric home appliance according to the implementation of the present application, is a display unit 232 for visually outputting information, it is possible to recognize an output mode of the display unit, which, however, is merely an implementation of the present application and the scope of the present application is not limited by this implementation.

FIGS. 4(a), 4(b), 4(c), and 4(d) show display modes of the output unit based on which of the distance ranges, within which the distance value from the human body is. The distance value from the human body sequentially decreases in order from FIG. 4(a) to FIG. 4(d).

Referring to FIG. 4(a), the display unit 232 may output a current time. In a case in which the human body is not within the predetermined range, the display unit 232 may output the current time.

Referring to FIG. 4(b), the display unit 232 may further output a current use mode of the electric home appliance. For example, in a case in which the human body is within the predetermined range for the predetermined time or more, the display unit 232 may further output the current use mode of the electric home appliance. For example, the display unit 232 may display information indicating that the oven is being currently used in a food heating mode using high-frequency heating as in a microwave oven.

Referring to FIG. 4(c), the display unit 232 may display a procedure of the current use mode of the electric home appliance. For example, in a case in which the electric home appliance is being currently operated in a use mode corresponding to the microwave oven, the display unit 232 may output information indicating that the electric home appliance is being sequentially controlled through adjustment, selection, and start procedures.

The display unit 232 may output a procedure which is being currently performed. For example, the display unit 232 may underline text corresponding to selection, which is a procedure which is being currently performed, to indicate that selection is being currently performed.

Referring to FIG. 4(d), the display unit 232 may display information for function setting. For example, in a case in which the electric home appliance is an oven, the display unit 232 may output objects for setting functions, such as a microwave oven, roast, an oven, steam, and food drying. However, the present application is not limited thereto.

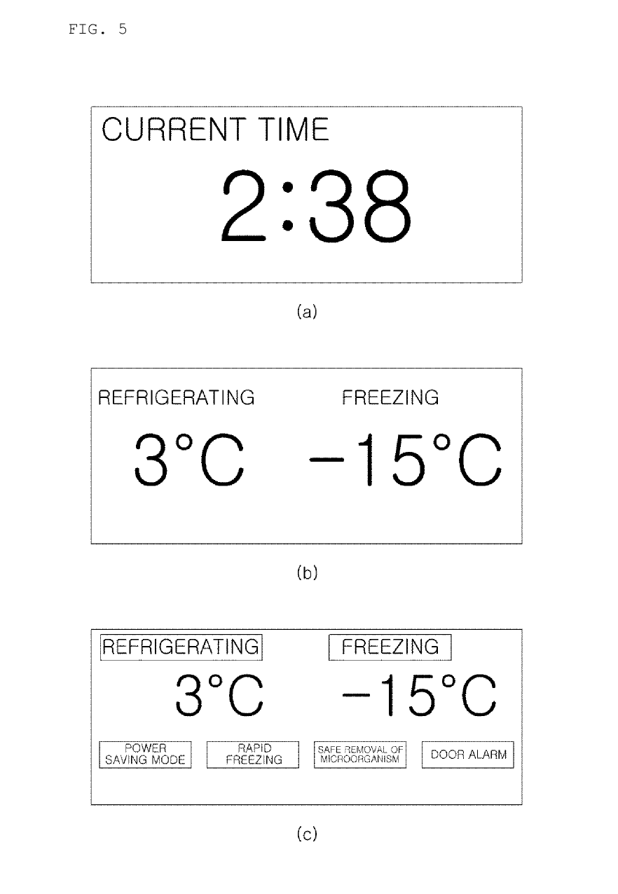

Referring to FIG. 5, in a case in which an output unit of a refrigerator, which is a further example of the electric home appliance according to the implementation of the present application, is a display unit 232 for visually outputting information, it is possible to recognize an output mode of the display unit, which, however, is merely an implementation of the present application and the scope of the present application is not limited by this implementation.

FIGS. 5(a), 5(b), and 5(c) show display modes of the output unit based on which of the distance ranges, within which the distance value from the human body is. The distance value from the human body sequentially decreases in order from FIG. 5(a) to FIG. 5(c).

Referring to FIG. 5(a), the display unit 232 may output a current time. In a case in which the human body is not within the predetermined range, the display unit 232 may output the current time.

Referring to FIG. 5(b), the display unit 232 may output a current temperature. In a case in which the human body is not within the predetermined range, the display unit 232 may output the current temperature. For example, the display unit 232 may output current temperatures of a refrigerator compartment and a freezer compartment. However, the present application is not limited thereto.

Referring to FIG. 5(c), the display unit 232 may display information for function setting. For example, in a case in which the electric home appliance is a refrigerator, the display unit 232 may output objects for setting functions, such as a power saving mode, rapid freezing, safe removal of microorganism, and door alarm. However, the present application is not limited thereto.

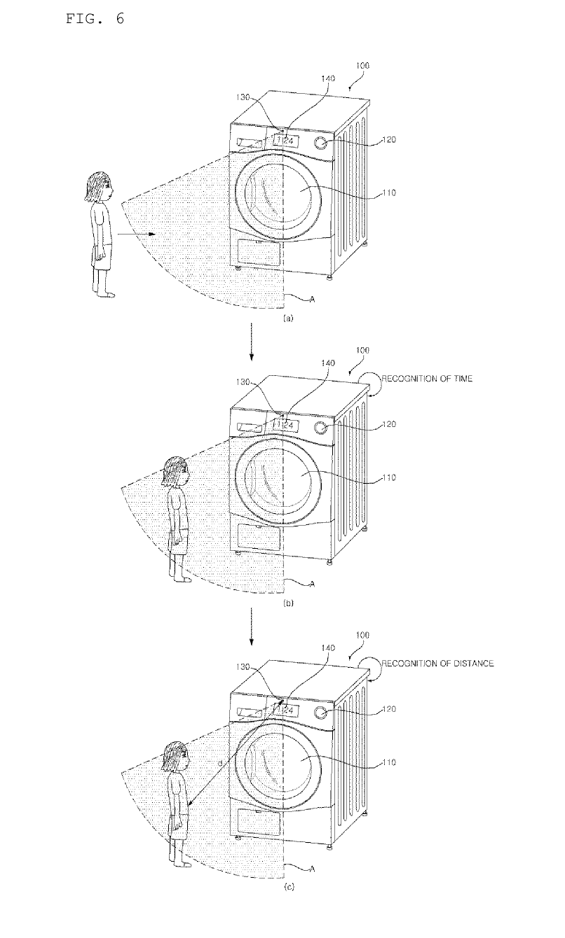

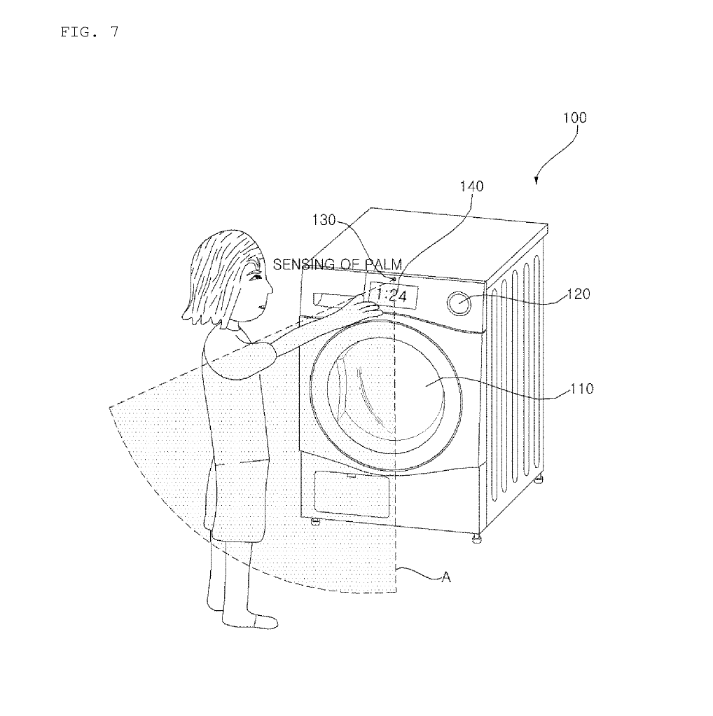

FIGS. 6 and 7 illustrates an example control process of the electric home appliance according to the implementation of the present application.

Referring to FIG. 6(a), the sensing unit 140 may sense whether a human body is within a predetermined range.

Referring to FIG. 6(a), the electric home appliance may recognize a time during which the human body is within the predetermined range. Referring to FIG. 6(b), in a case in which the electric home appliance according to the implementation of the present application is a washing machine, the electric home appliance may determine whether the human body is within the predetermined range for a predetermined time or more.

In a case in which the human body is within the predetermined range for the predetermined time or more, the electric home appliance may add the number of information items output by the output unit 130. In a case in which the human body is within the predetermined range for the predetermined time or more, the electric home appliance may recognize a distance d from the human body.

Referring to FIG. 6(c), the electric home appliance may recognize the distance from the human body. The electric home appliance may output information in different modes based on the distance from the human body. For example, as the distance from the human body decreases, the electric home appliance may output detailed information through the output unit 130. On the other hand, as the distance from the human body increases, the electric home appliance may output simple information through the output unit 130. For example, in a case in which the distance from the human body is large, the electric home appliance may output only a current time through the output unit 130.

The electric home appliance may decide a type of information to be output, an information display mode, etc. based on a distance value from the human body. For example, the electric home appliance may decide the size of text output by the output unit 130, the type, quality, and volume of a notification sound output by the output unit 130, or the type of information output by the output unit 130 based on a distance range, within which the distance value from the human body is.

Referring to FIG. 7, the electric home appliance according to an implementation of the present application may sense a palm of the human body through the sensing unit 140. For example, the sensing unit 140 may sense lines of the palm or a fingerprint of the human body. However, the present application is not limited thereto.

The electric home appliance may recognize identity of the human body based on the lines of the palm or the fingerprint of the human body sensed by the sensing unit 140. The electric home appliance may decide a method of displaying information through the output unit 130 or information to be displayed by the output unit 130 based on the identity of the human body. However, the present application is not limited thereto.

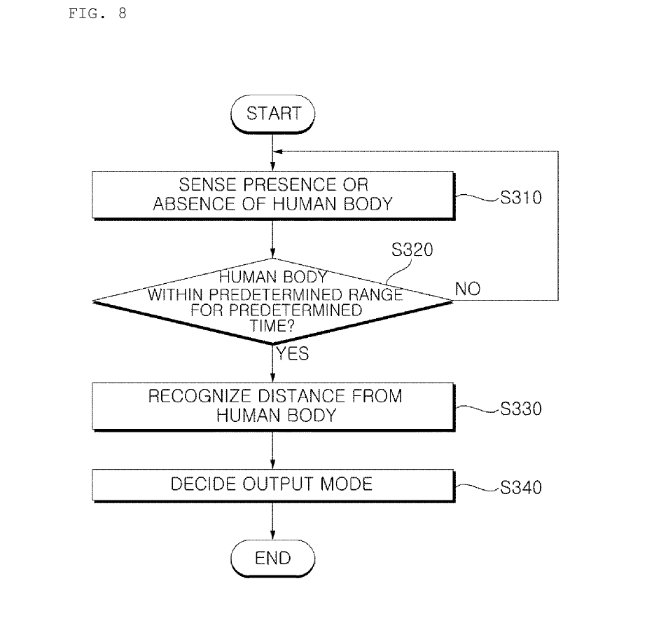

FIG. 8 illustrates an example flowchart for a control method of an electric home appliance according to an implementation of the present application.

Referring to FIG. 8, a control method of an electric home appliance according to an implementation of the present application may include a step of sensing whether a human body is within a predetermined range (S310), a step of calculating a distance value from the human body (S330), and a step of deciding an information output mode of an output unit based on presence or absence of the human body and the distance value from the human body (S340).

The step of sensing whether the human body is within the predetermined range (S310) may sense presence or absence of the human body through the sensing unit. The control method of the electric home appliance according to the implementation of the present application may further include a step of recognizing a time during which the human body is within the predetermined range (S320) after the step of sensing whether the human body is within the predetermined range (S310). That is, the controller 210 may sense presence or absence of the human body through the sensing unit 240 (S310). In a state in which the presence of the human body is sensed, the controller 210 may determine whether the human body is within the predetermined distance for a predetermined time or more (S320).

The step of sensing whether the human body is within the predetermined range (S310) may include the step of determining whether the human body is within the predetermined distance for the predetermined time or more (S320). The step of determining whether the human body is within the predetermined distance for the predetermined time or more (S320) may initialize time in a case in which the human body deviates from the predetermined distance. The step of determining whether the human body is within the predetermined distance for the predetermined time or more (S320) may recalculate time from the beginning in a case in which the human body reenters the predetermined range. That is, in a case in which the human body deviates from the predetermined distance, the controller 210 may initialize time. In addition, in a case in which the human body reenters the predetermined range, the controller 210 may recalculate time from the beginning.

The step of calculating the distance value from the human body (S330) may calculate a value of the distance from the human body in a case in which the human body is within the predetermined range for the predetermined time or more. That is, in a case in which the human body is within the predetermined range for the predetermined time or more, the controller 210 may calculate the value of the distance from the human body (S330).

The step of deciding the information output mode of the output unit based on presence or absence of the human body and the distance value from the human body (S340) may decide an information output mode based on the distance value from the human body in a case in which the human body is within the predetermined range for the predetermined time or more. That is, in a case in which the human body is within the predetermined range for the predetermined time or more, the controller 210 may decide the information output mode based on presence or absence of the human body and the distance value from the human body (S340). For example, the information output mode may be the size of text or voice outputting information or type of information. However, the present application is not limited thereto.

The step of deciding the information output mode of the output unit (S340) may decide quantity of information output by the output unit 230 based on a distance range, within which the distance value from the human body is, among the predetermined distance ranges. That is, the controller 210 may decide quantity of information output by the output unit 230 based on a distance range, within which the distance value from the human body is, among the predetermined distance ranges.

The step of deciding the information output mode of the output unit (S340) may decide the size of text output by the output unit 230, the type, quality, and volume of a notification sound output by the output unit 230, or the type of information output by the output unit 230 based on the distance range, within which the distance value from the human body is. That is, the controller 210 may decide the size of text output by the output unit 230, the type, quality, and volume of a notification sound output by the output unit 230, or the type of information output by the output unit 230 based on the distance range, within which the distance value from the human body is.

For example, at the step of deciding the information output mode of the output unit 230 (S340), the controller 210 may add the number of information items output by the output unit 230 in a case in which the human body is within the predetermined range for the predetermined time or more. At the step of deciding the information output mode of the output unit 230 (S340), the controller 210 may increase quantity of information output by the output unit 230 as the distance value from the human body decreases.

The step of deciding the information output mode of the output unit (S340) may further include a step of recognizing use information of the human body. For example, the step of deciding the information output mode of the output unit (S340) may recognize presence or absence of use information of the sensed human body and output a plurality of use modes through the output unit in order of high use frequency based on the use information.

The control method of the electric home appliance according to the implementation of the present application may further include a step of determining whether the sensed human body gazes at the electric home appliance. At the step of deciding the information output mode of the output unit 230 (S340), the controller 210 may decrease luminance or volume of the output unit in a case in which the human body does not gaze at the electric home appliance.

For example, in a case in which the output unit 230 is a display unit 232 for visually outputting information, the controller 210 may decrease luminance of the output unit in a case in which the human body does not gaze at the electric home appliance. In a case in which the output unit 230 is a speaker 234 for aurally outputting information, the controller 210 may decrease volume of the output unit in a case in which the human body does not gaze at the electric home appliance.

As is apparent from the above description, an electric home appliance and a control method thereof according to an implementation of the present application may have the following and other effects.

In the electric home appliance and the control method thereof according to the implementation of the present application, it is possible to adjust information output by the output unit based on location of a user such that the user can easily recognize a state of the electric home appliance.

In the electric home appliance and the control method thereof according to the implementation of the present application, it is possible to display necessary for the user through the output unit based on a time during which the user is with a predetermined range such that more detailed information can be provided when the user is within a short distance, thereby providing information suitable for eyesight of the human body.

In the electric home appliance and the control method thereof according to the implementation of the present application, it is possible to recognize, in a case in which a user having previous use information approaches the electric home appliance, a use mode having high use frequency based on the use information, thereby achieving convenient use of the electric home appliance.

In the electric home appliance and the control method thereof according to the implementation of the present application, it is possible to decrease luminance of the display unit in a case in which the user does not gaze at the electric home appliance, thereby reducing power consumption.

In the electric home appliance and the control method thereof according to the implementation of the present application, it is possible to change an output mode in a case in which there is no user response although information is provided to the user, thereby properly providing information to the user.

Although all elements constituting the implementations of the present application are described to be integrated into a single one or to be operated as a single one, the present application is not necessarily limited to such implementations. According to implementations, all of the elements may be selectively integrated into one or more and be operated as one or more within the object and the scope of the present application.

Each of the elements may be implemented as independent hardware. Alternatively, some or all of the elements may be selectively combined into a computer program having a program module performing some or all functions combined in one or more pieces of hardware.

A plurality of codes and code segments constituting the computer program may be easily reasoned by those skilled in the art to which the present application pertains. The computer program may be stored in a computer readable media such that the computer program is read and executed by a computer to implement implementations of the present application. Computer program storage media may include magnetic recording media, optical recording media, and carrier wave media.

The term “comprises”, “includes”, or “has” described herein should be interpreted not to exclude other elements but to further include such other elements since the corresponding elements may be inherent unless mentioned otherwise.

All terms including technical or scientific terms have the same meanings as generally understood by a person having ordinary skill in the art to which the present application pertains unless mentioned otherwise.

Generally used terms, such as terms defined in a dictionary, should be interpreted to coincide with meanings of the related art from the context. Unless obviously defined in the present application, such terms are not interpreted as ideal or excessively formal meanings.

Although the preferred implementations of the present application have been disclosed for illustrative purposes, those skilled in the art will appreciate that various modifications, additions and substitutions are possible without departing from the scope and spirit of the application as disclosed in the accompanying claims.

The implementations disclosed in the present application are provided not to limit the technical concept of the present application but to illustrate the technical concept of the present application. Therefore, the scope of the technical concept of the present application is not limited by such implementations. The scope of the protection of the present application should be determined by reasonable interpretation of the appended claims and all technical concepts coming within the equivalency range of the present application should be interpreted to be embraced in the scope of the right of the present application.

What is claimed is:

1. An electric home appliance comprising:
a sensing unit configured to sense whether a user's body is within a predetermined range from the electric home appliance and to determine a distance value of the user's body from the electric home appliance;
an output unit configured to output information; and
a controller configured to determine, from among a plurality of predetermined distance ranges, a distance range that corresponds to the distance value of the user's body from the electric home appliance and to select, from among a plurality of information output modes, an information output mode of the output unit based on the determined distance range.

2. The electric home appliance according to claim 1, wherein the controller is configured to determine a size of text, a type, quality, and volume of a notification sound, or a type of information output by the output unit based on the determined distance range.

3. The electric home appliance according to claim 1, wherein the controller is configured to determine a size of text of information that is output by the output unit based on the determined distance range.

4. The electric home appliance according to claim 1, wherein the controller is configured to determine a type, quality, and volume of a notification sound that is output by the output unit based on the determined distance range.

5. The electric home appliance according to claim 1, wherein the controller is configured to determine a type of information that is output by the output unit based on the determined distance range.

6. The electric home appliance according to claim 1, wherein
the plurality of predetermined distance ranges comprise a first distance range, a second distance range that is greater than the first distance range, and a third distance range that is greater than the second distance range, and
the controller is configured to control the output unit to display at least one selected from among a current time, a current use mode, and a remaining operation time of the current use mode based on the distance value of the user's body being within the third distance range.

7. The electric home appliance according to claim 1, wherein
the plurality of predetermined distance ranges comprise a first distance range, a second distance range that is greater than the first distance range, and a third distance range that is greater than the second distance range, and
the controller is configured to control the output unit to display a current time based on the distance value of the user's body being within the third distance range.

8. The electric home appliance according to claim 1, wherein
the plurality of predetermined distance ranges comprise a first distance range, a second distance range that is greater than the first distance range, and a third distance range that is greater than the second distance range, and
the controller is configured to control the output unit to display a current use mode based on the distance value of the user's body being within the third distance range.

9. The electric home appliance according to claim 1, wherein
the plurality of predetermined distance ranges comprise a first distance range, a second distance range that is greater than the first distance range, and a third distance range that is greater than the second distance range, and
the controller is configured to control the output unit to display a remaining operation time of a current use mode based on the distance value of the user's body being within the third distance range.

10. The electric home appliance according to claim 6, wherein the controller is configured to control the output unit to display various temperature values necessary for control or a procedure of the current use mode based on the distance value of the user's body being within the second distance range.

11. The electric home appliance according to claim 6, wherein the controller is configured to control the output unit to display various temperature values necessary for control based on the distance value of the user's body being within the second distance range.

12. The electric home appliance according to claim 6, wherein the controller is configured to control the output unit to display a procedure of the current use mode based on the distance value of the user's body being within the second distance range.

13. The electric home appliance according to claim 6, wherein the controller is configured to control the output unit to display information for function setting based on the distance value of the user's body being within the first distance range.

14. The electric home appliance according to claim 1, wherein the controller is configured to increase a quantity of information that is output by the output unit based on the distance value of the user's body decreasing.

15. The electric home appliance according to claim 1, wherein
the output unit comprises a speaker configured to output a notification sound indicating an operation state of the electric home appliance, and
the controller is configured to adjust a volume of the speaker based on the distance value of the user's body.

16. A control method of an electric home appliance comprising:
sensing, via a sensing unit, whether a user's body is within a predetermined range from the electric home appliance;
calculating a distance value of the user's body from the electric home appliance; and
determining an information output mode of an output unit based on presence or absence of the user's body and the distance value.

17. The control method according to claim 16, wherein determining the information output mode of the output unit comprises increasing a quantity of information that is output by the output unit as the distance value of the user's body decreases.

18. The control method according to claim 16, wherein determining the information output mode of the output unit comprises determining, from among a plurality of predetermined distance ranges, a distance range that corresponds to the distance value of the user's body from the electric home appliance and deciding a quantity of information that is output by the output unit based on the determined distance range.

19. The control method according to claim 18, wherein determining the information output mode of the output unit comprises deciding a size of text, a type, quality, and volume of a notification sound, or a type of information that is output by the output unit based on the determined distance range.

20. The control method according to claim 18, wherein determining the information output mode of the output unit comprises deciding a size of text that is output by the output unit based on the determined distance range.
